(19) United States
(12) Patent Application Publication
(10) Pub. No.: US 2018/0326436 A1
(43) Pub. Date: Nov. 15, 2018

(54) MIST COATING FORMING APPARATUS AND MIST COATING FORMING METHOD

(71) Applicant: TOSHIBA MITSUBISHI-ELECTRIC INDUSTRIAL SYSTEMS CORPORATION, Chuo-ku (JP)

(72) Inventor: Tianming LI, Tokyo (JP)

(73) Assignee: TOSHIBA MITSUBISHI-ELECTRIC INDUSTRIAL SYSTEMS CORPORATION, Chuo-ku (JP)

(21) Appl. No.: 15/776,972

(22) PCT Filed: Dec. 11, 2015
(86) PCT No.: PCT/JP2015/084771

§ 371 Date: May 17, 2018

(51) Int. Cl. B05B 7/26; B05D 1/02; B05B 17/06

(52) U.S. Cl. CPC B05B 7/26; B05B 17/06; B05D 1/02

(57) ABSTRACT

In the present invention, a coating solution atomization mechanism implements a coating solution mist generating process for generating a coating solution mist by atomizing a coating solution using an ultrasonic transducer generating ultrasonic waves. A mist coating mechanism implements a coating solution mist coating process for coating the coating solution mist to the surface of a substrate by supplying the coating solution mist from a mist coating head to the surface of the substrate mounted on a moving stage. A baking and drying mechanism implements a baking and drying process for baking and drying, on a hot plate, the substrate to the surface of which the coating solution mist is coated to evaporate a solvent of a liquid film formed of the coating solution mist, thereby forming a thin film on the surface of the substrate.

### TECHNICAL FIELD

The present invention relates to a mist coating forming apparatus and a mist coating forming method for forming a thin film on a substrate subjected to film formation, using a mist of a coating solution sprayed by ultrasonic waves.

### BACKGROUND ART

In order to provide various functionalities (anti-reflection, anti-glare property, anti-fouling property, hydrophilicity, hydrophobicity) by coating a thin film to a coating object such as a film, a glass substrate, or a semiconductor wafer, various coating methods have been adopted depending on differences in properties (viscosity, surface tension) of a coating solution, characteristics (surface shape, surface tension) of a coating object (substrate subjected to film formation), film properties (film thickness, composition concentration in film, film hardness), and the like.

As a coating device for a coating object such as a film or a glass substrate, for example, there are a slit die coating device, a roll coating device, a bar coating device, and a gravure coating device which coat the whole amount of coating solution. In recent years, due to high performance of functional films, optical films, and flat display panels, precision required for thinning a coating film and preventing film thickness unevenness has been increased.

On the other hand, as coating devices that perform coating by forming the coating solution into droplets, for example, there are a spray coating device and a spin coating device. A spin coating device is widely used as a method for manufacturing a thin film on a semiconductor wafer. A spin coating method is a method of supplying droplets of a coating solution to the central portion of the surface of a substrate, and forming the thin film on the surface of the substrate by rotating the substrate at a high speed. In this method, since the coating solution is discarded when the substrate is rotated at a high speed, the utilization efficiency of the coating solution is low, and there are many problems when the method is coated to a large-sized coating object.

A spray coating method is a method of forming a thin film on the surface of a substrate by spraying a coating solution with a high pressure air gas. The spray coating method is disclosed in, for example, Patent Document 1. Since a spray gun of the spray coating device can move, it is adaptable to a large-sized coating object, but it is difficult to control the fine particle diameter of the sprayed coating solution by the high pressure air and the air flow rate, and the film thickness unevenness Is likely to occur in the thin film to be formed.

### PRIOR ART DOCUMENT

### Patent Document

Patent Document 1: Japanese Patent Application Laid-Open No. 2003-98699

### SUMMARY

### Problem to be Solved by the Invention

In a spray coating method such as the spray coating method as described above, the coating solution is atomized with the high pressure air gas introduced into a common spray gun while supplying the coating solution using the common spray gun. The fine particle diameter of the atomized coating solution is decreased by increasing the air pressure or the air flow rate when a supply amount of the coating solution is constant. Furthermore, the fine particle diameter is decreased by decreasing the supply amount of the coating solution when the air pressure or the air flow rate is constant. Since the fine particle diameter of the coating solution depends on the supply amount of the coating solution, the air pressure, and the air flow rate, there has been a problem that it is difficult to control the particle size of the fine particle diameter and to control the atomization amount of the small particle size together.

In the conventional spray coating method, a discharge amount of the coating solution is reduced, and the pressure or the flow rate of atomization air is increased to make the diameter of the spray atomized particles small or to make a concentration of the coating solution low so that the particles at the time of spraying adheres to the coating object while being dried during flight of particles, and thereby, a coated film is finished.

In the case of reducing the discharge amount of the coating solution and the case of decreasing the concentration of the coating solution, since a thin coating film is formed, it is necessary to form a film by increasing the number of times of lamination according to the film thickness. Increasing the number of times of the coating improves the uniformity of the coating film, but there is a problem of lowering the production efficiency.

Further, in order to atomize the spray more, it is necessary to use the high air pressure or to increase the air flow rate. However, there is a problem that when continuously performing the coating two or more times, the high pressure and a large amount of air cause the turbulence of the solution film since the high pressure and a large amount of air for atomization are strongly coated to the surface of the coating object.

Furthermore, in the spray coating method, although the rotational speed of the coating object and the moving speed of the spray gun can optionally be set, there has been a problem that uniform coating cannot be achieved unless the rotational speed of the coating object and the moving speed of the spray gun are adjusted in a well-balanced manner.

The present invention has been made to solve the above problems, and an object of the present invention is to provide a mist coating forming apparatus and a mist coating forming method that can font' a uniform thin film having a film thickness of 100 nm or less.

### Means to Solve the Problem

A mist coating forming apparatus according to the present invention includes an coating solution atomization mechanism configured to atomize a coating solution containing a predetermined raw material in an atomization container by using an ultrasonic transducer to obtain a coating solution mist in a form of droplets; a mist coating mechanism having a mounting part on which a substrate subjected to film formation is mounted, and configured to supply the coating solution mist to the substrate, and to coat the coating solution mist to the surface of the substrate; and a baking and drying mechanism configured to bake and dry the coating solution mist coated to the surface of the substrate to form a thin film containing the predetermined raw material on the surface of the substrate.

### Effects of the Invention

The mist coating forming apparatus of the present invention according to claim 1 coats a coating solution mist to the surface of a substrate by a mist coating mechanism and then bakes and dries the coating solution mist by a baking and drying mechanism to form a thin film containing a predetermined raw material on the surface of the substrate, and thereby a thin film having a film thickness of 100 nm or less can be formed on the substrate with high uniformity.

The objects, features, aspects, and advantages of the present invention will become more apparent from the following detailed description and the accompanying drawings.

### BRIEF DESCRIPTION OF DRAWINGS

FIG. 1 is an explanatory view schematically showing a configuration of a mist coating forming apparatus according to Embodiment 1 of the present invention.

FIG. 2 is a plan view showing a bottom structure of a mist coating head shown in FIG. 1.

FIG. 3 is a flowchart showing a process procedure of a mist coating forming method and a film thickness verification method of a thin film according to Embodiment 1.

FIG. 4 is an explanatory view schematically showing a positional relationship of a head bottom surface relative to the substrate shown in FIG. 1.

FIG. 5 is an explanatory view schematically showing a surface of the substrate to be verified.

FIG. 6 is a graph showing a film thickness measurement result in a measurement region shown in FIG. 5.

FIG. 7 is a graph showing measured film thicknesses in each of a plurality of measurement regions.

FIG. 8 is an explanatory view schematically showing process contents of another measurement process.

FIG. 9 is a graph showing measurement results of performing another measurement process.

FIG. 10 is a graph showing film thicknesses of thin films at different stage moving speeds.

FIG. 11 is an explanatory view showing, in tabular form, an average film thickness at each moving speed and a standard deviation of a film thickness.

FIG. 12 is an explanatory view schematically showing control contents of a mist controller in a coating solution atomization mechanism of Embodiment 2.

FIG. 13 is an explanatory view schematically showing characteristic portions of a mist coating forming apparatus of Embodiment 3.

FIG. 14 is a plan view showing a bottom surface structure of a plurality of mist coating heads.

### DESCRIPTION OF EMBODIMENTS

Hereinafter, embodiments of the present invention will be described with reference to the drawings.

### Embodiment 1

(Mist Coating Forming Apparatus)

FIG. 1 is an explanatory view schematically showing a configuration of a mist coating forming apparatus according to Embodiment 1 of the present invention. As shown in FIG. 1, the mist coating forming apparatus of Embodiment 1 has a coating solution atomization mechanism 50, a mist coating mechanism 70 and a baking and drying mechanism 90 as main components.

The coating solution atomization mechanism 50 implements a coating solution mist generating process for generating a coating solution mist 6 by atomizing, using an ultrasonic transducer 1 generating ultrasonic waves, a coating solution 5 in an atomization container 4 into droplets having a narrow particle size distribution and a central particle size of about 4 μm. The coating solution mist 6 is transported to the mist coating mechanism 70 via a mist supply line 22 by a carrier gas supplied from a carrier gas supply part 16.

The mist coating mechanism 70 implements a coating solution mist coating process for coating the coating solution mist 6 to the surface of a substrate 9 by receiving the coating solution mist 6 from the mist supply line 22 and supplying the coating solution mist 6 from a mist coating head 8 to the surface of the substrate 9 (substrate subjected to film formation) mounted on a moving stage 10 (mounting part).

The baking and drying mechanism 90 implements a baking and drying process for baking and drying, on a hot plate 13, the substrate 9 to the surface of which the coating solution mist 6 is coated to evaporate a solvent in the coating solution mist 6, thereby forming, on the surface of the substrate 9, a thin film containing a raw material of a silicone compound (a siloxane polymer having added additives such as a filler and a cross-linking agent, a siloxane polymer reacted with another organic compound) contained in the coating solution mist 6.

(Coating Solution Atomization Mechanism 50)

In the coating solution atomization mechanism 50, an ultrasonic frequency within the range of 1.5 to 2.5 MHz, for example, can be used for the ultrasonic transducer 1. Water 3 is introduced as a medium for ultrasonic wave propagation generated by the ultrasonic transducer 1 to a water tank 2 provided above the ultrasonic transducer 1, and by driving the ultrasonic transducer 1, the coating solution 5 in the atomization container 4 is formed into droplets to obtain the coating solution mist 6 of micrometer-sized droplets having a narrow particle size distribution and a central particle diameter of about 4 μm.

The coating solution 5 is a coating solution which can be diluted with a solvent with low viscosity such as methanol, toluene, water, hexane, ether, methyl acetate, ethyl acetate, vinyl acetate, or ethyl chloride, and has a viscosity of 1.1 mPa·S or less even if the viscosity of the coating solution is high.

By supplying the carrier gas supplied from the carrier gas supply part 16 from a carrier gas introduction line 21 into the atomization container 4, the coating solution mist 6, which is in the form of droplets, sprayed in the internal space of the atomization container 4 is transported toward the mist coating head 8 of the mist coating mechanism 70 via the mist supply line 22. Nitrogen gas or air is mainly used as a carrier gas for the purpose of transporting the coating solution mist 6, and a carrier gas flow rate is controlled so as to be 2 to 10 (L/min) by a mist controller 35. Note that, a valve 21b is disposed in the carrier gas introduction line 21 and is a valve for adjusting the carrier gas flow rate.

The mist controller 35 controls the carrier gas flow rate of the carrier gas supplied from the carrier gas supply part 16 by controlling the degree of opening and closing of the valve 21b, and controls the presence/absence of vibration of the ultrasonic transducer 1, the ultrasonic frequency, and the like.

(Mist Coating Mechanism 70)

The mist coating mechanism 70 has, as main components, the mist coating head 8 and a moving stage 10 (mounting part) which is movable with the film forming substrate 9 mounted thereon under the control of a movement controller 37.

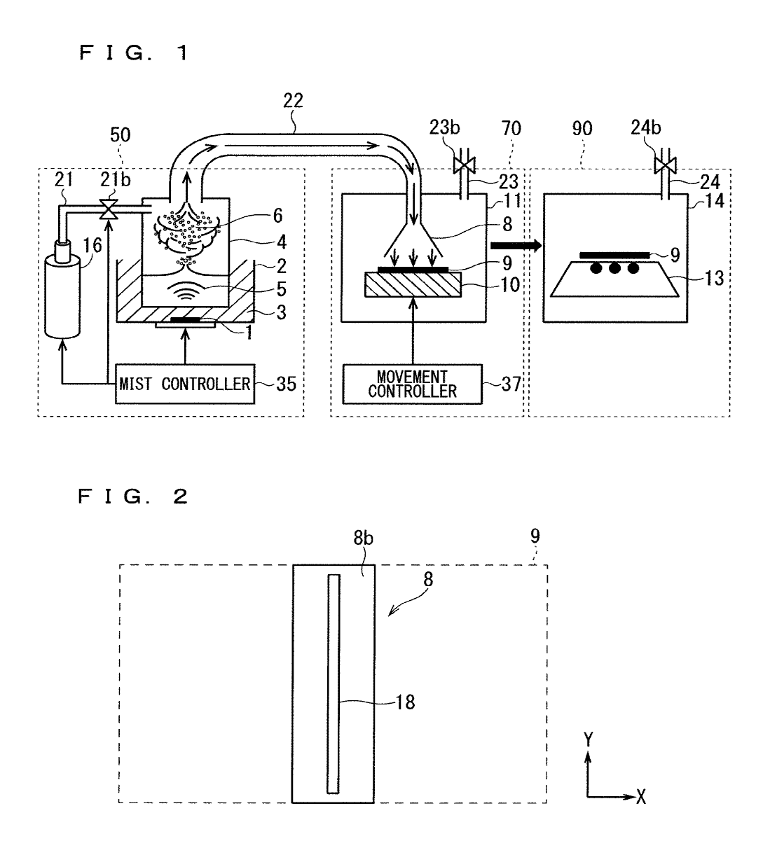

FIG. 2 is a plan view showing a bottom structure of the mist coating head 8. The XY coordinate axes are shown in FIG. 2. As shown in FIG. 2, a mist ejection port 18 of a slit shape in which the Y direction (predetermined direction) is a longitudinal direction is formed in the head bottom surface 8b of the mist coating head 8.

In FIG. 2, a hypothetical plane position of the substrate 9 existing under the head bottom surface 8b of the mist coating head 8 is shown. The substrate 9 is configured in a rectangular shape in which a side in the X direction is a long side and a side in the Y direction is a short side.

As shown in FIG. 2, the mist ejection port 18 provided in the head bottom surface 8b is provided in a slit shape in which the shorter side forming direction (Y direction) of the substrate 9 is a longitudinal direction, and its forming length (Y direction length) is set to be approximately equal to a short side width of the substrate 9.

Therefore, for example, by supplying the coating solution mist 6 straightened in the mist coating head 8 from the mist ejection port 18 while moving the substrate 9 along the X direction by the moving stage 10, it is possible to coat the coating solution mist 6 to almost the entire surface of the substrate 9. In addition, since the mist ejection port 18 is formed in a slit shape, by adjusting the forming length in the longitudinal direction (Y direction) of the mist coating head 8, a forming length of the mist ejection port can also be coated to the substrate 9 having a wide short-side width without being limited by the short side width of the substrate 9 which is a substrate subjected to film formation. Specifically, by providing the mist coating head 8 with a width in a longitudinal direction matching the assumed maximum short-side width of the substrate 9, the forming length of the mist ejection port 18 can be made substantially equal to the maximum short-side width of the substrate 9.

Note that, when the moving stage 10 on which the substrate 9 is mounted on the upper side moves along the X direction in a state of being 2 to 5 mm away from the head bottom surface 8b of the mist coating head 8 under the control of the movement controller 37, it is possible to coat an extremely thin liquid film by the coating solution mist 6 to almost the entire surface of the substrate 9. At this time, the thickness of the liquid film can be adjusted by changing the moving speed of the moving stage 10 by the movement controller 37.

That is, the movement controller 37 moves the moving stage 10 along a moving direction (X direction in FIG. 2) which matches a transverse direction of the mist ejection port 18 of the mist coating head 8, and variably controls a moving speed of the moving stage 10 along the moving direction.

The mist coating head 8 and the moving stage 10 are disposed in the mist coating chamber 11, and a mixed gas of a solvent vapor of the coating solution mist 6 evaporated in the mist coating chamber 11 and the carrier gas flows through an exhaust gas output line 23, is treated by an exhaust treatment device (not shown), and then released to the atmosphere. A valve 23b is a valve provided in the exhaust gas output line 23.

(Baking and Drying Mechanism 90)

The baking and drying mechanism 90 has a hot plate 13 provided in a baking-drying chamber 14 as a main component. The substrate 9 to the surface of which (a liquid film of) the coating solution mist 6 is coated by the mist coating mechanism 70 is mounted on the hot plate 13 in the baking-drying chamber 14.

By performing the baking and drying process on the substrate 9 to which the coating solution mist 6 is coated using the hot plate 13, it is possible to evaporate a solvent of a liquid film formed of the coating solution mist 6 and to form a thin film containing a raw material in the coating solution 5 on the surface of the substrate 9. A solvent vapor of the coating solution 5 produced by the baking and drying process is discharged to the atmosphere from an exhaust gas output line 24 after being treated by an exhaust treatment device (not shown).

Note that, in the example shown in FIG. 1, the baking and drying process is implemented using the hot plate 13; however, the baking and drying mechanism 90 may be configured in an aspect in which hot air is supplied into the baking-drying chamber 14 without using the hot plate 13.

(Mist Coating Forming Method)

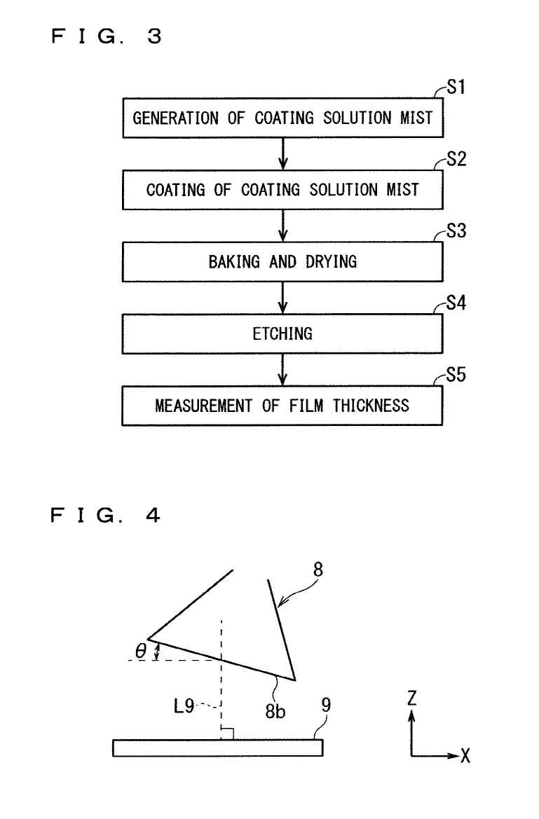

FIG. 3 is a flowchart showing a process procedure of a mist coating forming method implemented using the mist coating forming apparatus shown in FIG. 1 and a subsequent film thickness verification method of a thin film. First, with reference to FIG. 3, the process procedure of the mist coating forming method will be described.

In step S1, the coating solution atomization mechanism 50 implements the coating solution mist generating process for generating the coating solution mist 6 in the form of droplets by atomizing the coating solution 5 in the atomization container 4 using the ultrasonic transducer 1.

Specifically, the coating solution 5 includes 1 wt % (percent by weight) of silicon coding raw material, and two ultrasonic transducers 1 oscillating at 1.6 MHz are driven to spray the coating solution 5, and the coating solution mist 6 generated in the atomization container 4 is transported to the mist coating head 8 in the mist coating mechanism 70 via the mist supply line 22 by supplying a nitrogen carrier gas whose carrier gas flow rate is 2 L/min from the carrier gas supply part 16.

Next, in step S2, the mist coating mechanism 70 implements the coating solution mist coating process for coating the coating solution mist 6 to the surface of the substrate 9 by mounting, on the moving stage 10, the substrate 9 subjected to coating and supplying the coating solution mist 6 from the mist ejection port 18 of the mist coating head 8.

Specifically, the coating solution mist 6 straightened in the mist coating head 8 is supplied to the surface of the substrate 9 through the mist ejection port 18 formed in a slit shape, and thereby the coating solution mist coating process is implemented. The substrate 9 has a rectangular surface having a long side of 120 (mm) and a short side of 60 (mm).

The substrate 9 mounted (set) on the moving stage 10 is present at a distance of 2 to 5 mm below the head bottom surface 8b, and under the control of the movement controller 37, the moving stage 10 is moved (scanned) in the X direction in FIG. 2, and thereby, an extremely thin liquid film of the coating solution mist 6 is formed on almost the entire surface of the substrate 9. The movement speed of the moving stage 10 can be variably controlled by the movement controller 37 within the range of 1 to 50 (mm/sec).

In this way, only the moving stage 10 on which the substrate 9 is mounted is moved while fixing the mist coating head 8 to coat the coating solution mist 6 to the surface of the substrate 9, and thereby, the coating solution mist 6 can be relatively easily coated to the surface of the substrate 9.

In this case, in Embodiment 1, since the pressure and the flow rate of the carrier gas supplied from the carrier gas supply part 16 are smaller than the gas pressure and the flow rate of a high pressure air gas of the conventional spray gun, is possible to suppress, as compared with conventional one, the turbulence of the liquid film caused by the coating solution mist 6 strongly striking the surface of the substrate 9 in the coating solution mist coating process. In addition, turbulence of the liquid film by the coating solution mist 6 can be further suppressed by the following measures.

FIG. 4 is an explanatory view schematically showing a positional relationship of the head bottom surface 8b relative to the substrate 9. In FIG. 4, the XZ coordinate axes are also shown. As shown in FIG. 4, by providing the head bottom surface 8b of the mist coating head 8 with an inclination θ with respect to the surface forming direction (X direction in FIG. 4) of the substrate 9, it is possible to eject the coating solution mist 6 in the oblique direction by the angle θ from a perpendicular line L9 of the substrate 9 from the mist ejection port 18.

By providing the head bottom surface 8b of the mist coating head 8 with the inclination θ with respect to the surface forming direction of the substrate 9 as described above, it is possible to effectively suppress the turbulence of the liquid film caused at the time when the coating solution mist 6 strikes the surface of the substrate 9 due to the flow rate of the carrier gas supplied from the carrier gas supply part 16 and to coat the coating solution mist 6 more uniformly to the surface of the substrate 9.

Next, in step S3, the baking and drying mechanism 90 implements the baking and drying process for baking and drying the liquid film formed of the coating solution mist 6 coated to the surface of the substrate 9 to form, on the surface of the substrate 9, a thin film containing a raw material such as a silicone compound.

Through the mist coating forming method by steps S1 to S3 described above, a thin film having a film thickness of 100 μm or less can be formed on the substrate 9.

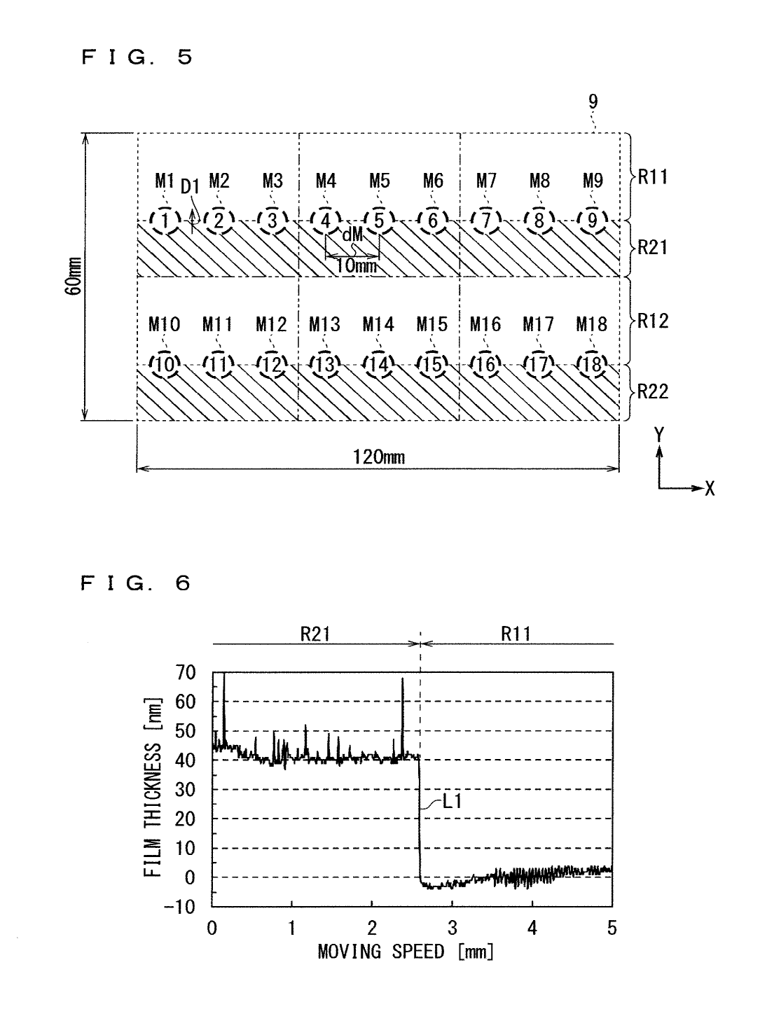

Next, with reference to FIG. 3 and FIG. 5, the film thickness verification process of the thin film formed on the surface of the substrate 9 by the mist coating forming method by the mist coating forming apparatus of Embodiment 1 will be described.

In step S4 in FIG. 3, an etching process for selectively etching and removing the thin film formed on the surface of the substrate 9 is implemented. Specifically, etching is carried out at room temperature for 10 minutes using an aqueous solution prepared by mixing methanol having a NaOH concentration of 4 wt % and pure water in the ratio of 1:1.

FIG. 5 is an explanatory view schematically showing a surface of the substrate to be verified. As shown in FIG. 5, the thin film in the etching removal regions R11 and R12 on the surface of the substrate 9 is selectively etched and removed by the etching process in step S4 to selectively leave the thin films in the non-etching regions R21 and R22.

Next, in step S5, a film thickness measurement process of the thin film formed on the substrate 9 is implemented. For measuring the film thickness, measurement was carried out using an existing stylus profilometer.

As shown in FIG. 5, the film thickness measurement points are the measurement regions M1 to M18, the measurement regions M1 to M9 are set in a region lying astride the etching removal region R11 and the non-etching region R21, and the measurement regions M10 to M18 are set in a region lying astride the etching removal region R12 and the non-etching region R22. Distances between adjacent measurement regions dM in the measurement regions M1 to M18 are set to 10 mm.

FIG. 6 is a graph showing the film thickness measurement result in the measurement region M1. In FIG. 6, as shown in the measurement direction D1 of FIG. 5, the film thickness is measured along the +Y direction. As shown in FIG. 6, the film thickness is measured around 40 mm in the non-etching region R21 and the film thickness is measured around 0 mm in the etching removal region R11. Therefore, the measured average value (excluding the noise portion) in the non-etching region R21 is the measured film thickness in the measurement region M1.

FIG. 7 is a graph showing measured film thicknesses in each of the measurement regions M1 to M18. In FIG. 7, the number i of the measurement region corresponds to the measurement region Mi. From the measurement result shown by the measurement point-specific film thickness measurement line L2 in FIG. 7, it was derived that an in-plane average film thickness was 47 nm and a standard deviation of the film thickness was 5 nm.

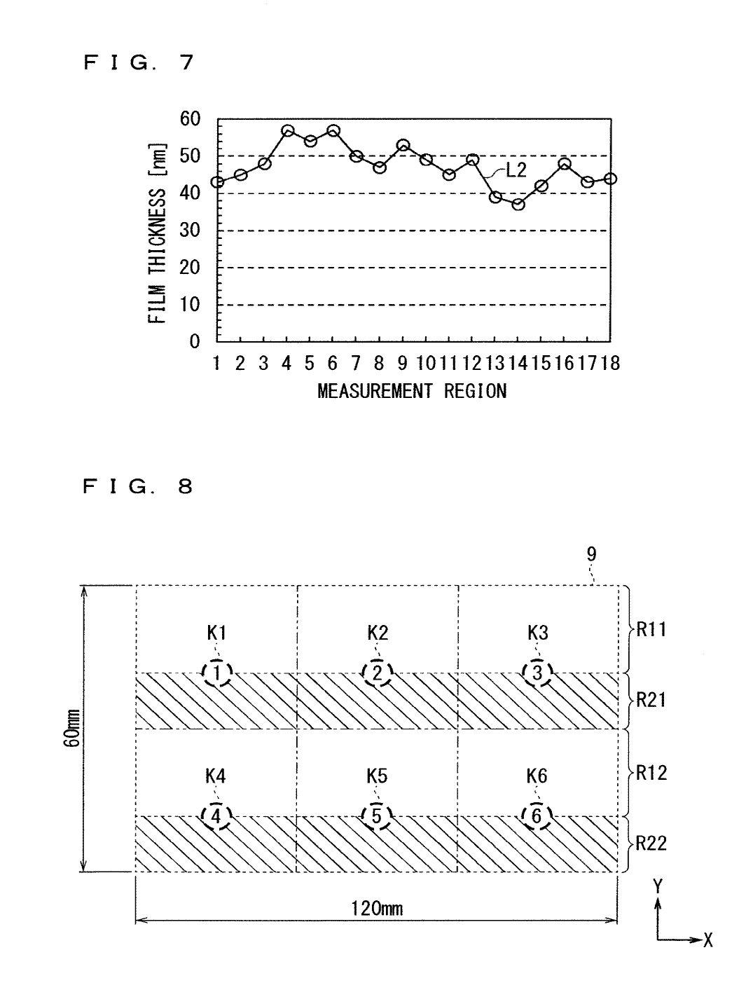

FIG. 8 is an explanatory view schematically showing process contents of another measurement process in step S5. As shown in FIG. 8, the film thickness measurement points are the measurement regions K1 to K6, the measurement regions K1 to K3 are set in a region lying astride an etching removal region R11 and a non-etching region R21, and the measurement regions K4 to K6 are set in a region lying astride an etching removal region R12 and a non-etching region R22. In another measurement process, an average of the measured film thicknesses in the measurement regions K1 to K6 is measured.

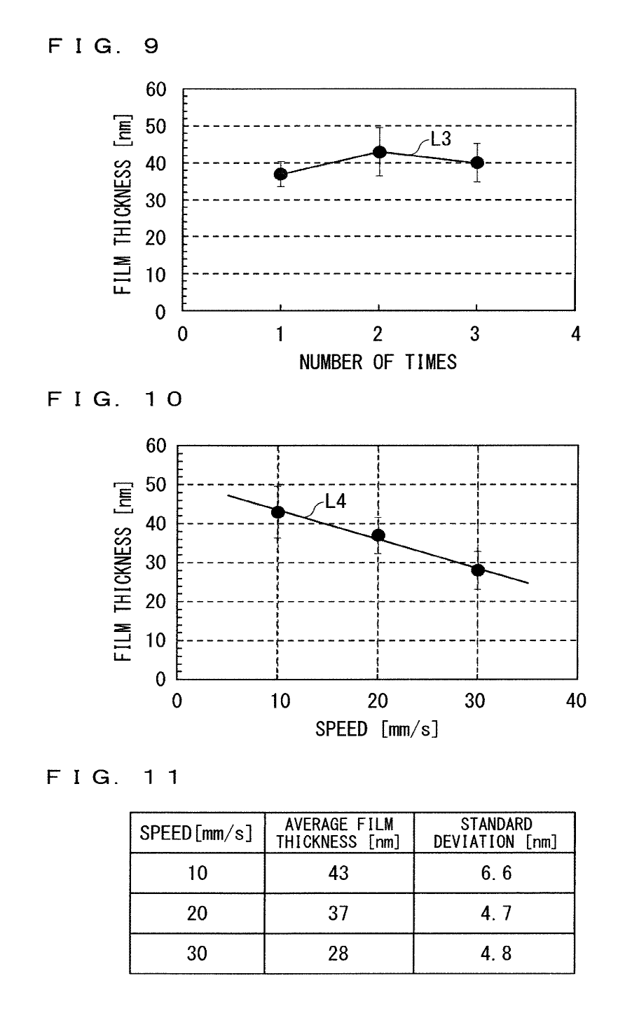

FIG. 9 is a graph showing measurement results obtained by implementing the mist coating forming method according to steps S1 to S3 three times, and performing the another measurement process shown in FIG. 8 in each of three times implementation. In FIG. 8, the number j of times corresponds to the j-th implementation result by another measurement process.

As shown in FIG. 8, since an average film thickness in the three times another measurement process is 40 nm and a standard deviation of the film thickness is 5 nm or less, it is found that by implementing the mist coating forming method using the mist coating forming apparatus of Embodiment 1, the thin film could be manufactured uniformly and stably even in film forming process of a thin film having a thickness of 100 nm or less.

There is a conventional problem that it is difficult to achieve uniformity as the thickness of the film becomes thinner under the condition that precision required for thinning a film of the coating solution mist 6 to be coated to the surface of the substrate 9 and preventing film thickness unevenness has been increased.

The mist coating forming method using the mist coating forming apparatus of Embodiment 1 was implemented to form a thinner thin film, and the film thickness distribution of the thin film was evaluated. At this time, the moving speed of the moving stage 10 controlled by the movement controller 37 was set to 10 (mm/sec), 20 (mm/sec), and 30 (mm/sec), and a thin film was formed on the surface of the substrate 9 by implementing of steps S1 to S3 one time, and the film thickness was measured.

FIG. 10 is a graph showing film thicknesses of thin films at different stage moving speeds. FIG. 11 is an explanatory view showing, in a tabular form, an average film thickness at each moving speed and a standard deviation of a film thickness. As shown in FIG. 10, it is found that by increasing the moving speed of the moving stage 10 by the movement controller 37, it is possible to reduce the film thickness of the thin film to be formed, and to allow the thinning of the film thickness of the thin film to progress.

As shown in FIG. 11, since the standard deviation of a film thickness is one fifth or less of the average film thickness even when thinning of the film thickness of the thin film progresses, it was found that the uniformity of the film thickness was maintained.

As described above, by implementing the mist coating forming method using the mist coating forming apparatus of the present embodiment, uniformity of the film thickness of the thin film to be formed can be maintained even if the film thickness is reduced to 100 nm or less.

(Effect etc.)

In the mist coating forming apparatus of Embodiment 1 which implements the mist coating forming method including steps S1 to S3 shown in FIG. 3, since the coating solution mist 6 is coated to the surface of the substrate 9 by the mist coating mechanism 70, and then the liquid film formed of the coating solution mist 6 on the surface of the substrate 9 is baked and dried by the baking and drying mechanism 90 to form a thin film containing the raw material in the coating solution 5 on the surface of the substrate 9, it is possible to uniformly form a thin film having a film thickness of 100 nm or less on the substrate.

Further, the mist coating head 8 is provided with the mist ejection port 18 in the head bottom surface 8b. The mist ejection port 18 is formed in a slit shape in which a short side forming direction (Y direction in FIG. 2; predetermined direction) of the substrate 9 having a rectangular surface is a longitudinal direction.

Accordingly, the short-side forming width of the substrate 9 and the forming length in a longitudinal direction of the mist ejection port 18 are set to the same length, and in a state in which the short side direction of the substrate 9 and the longitudinal direction of the mist ejection port 18 are aligned, the moving stage 10 on which the substrate 9 is mounted is moved along the long-side direction (first direction) of the substrate 9 under the control of the movement controller 37, and thereby, a thin film can be formed on almost the entire surface of the substrate 9.

Further, when the substrate subjected to film formation is a cylindrical substrate, by disposing the mist coating head 8 (mist ejection port 18) such that the coating solution mist 6 is supplied to a side surface of the cylindrical substrate while rotating the substrate about the central axis of the cylindrical portion, it is possible to form a thin film on the side surface of the cylindrical substrate.

In addition, by variably controlling the moving speed of the moving stage 10 by the movement controller 37, it is possible to form thin films having various thicknesses.

### Embodiment 2

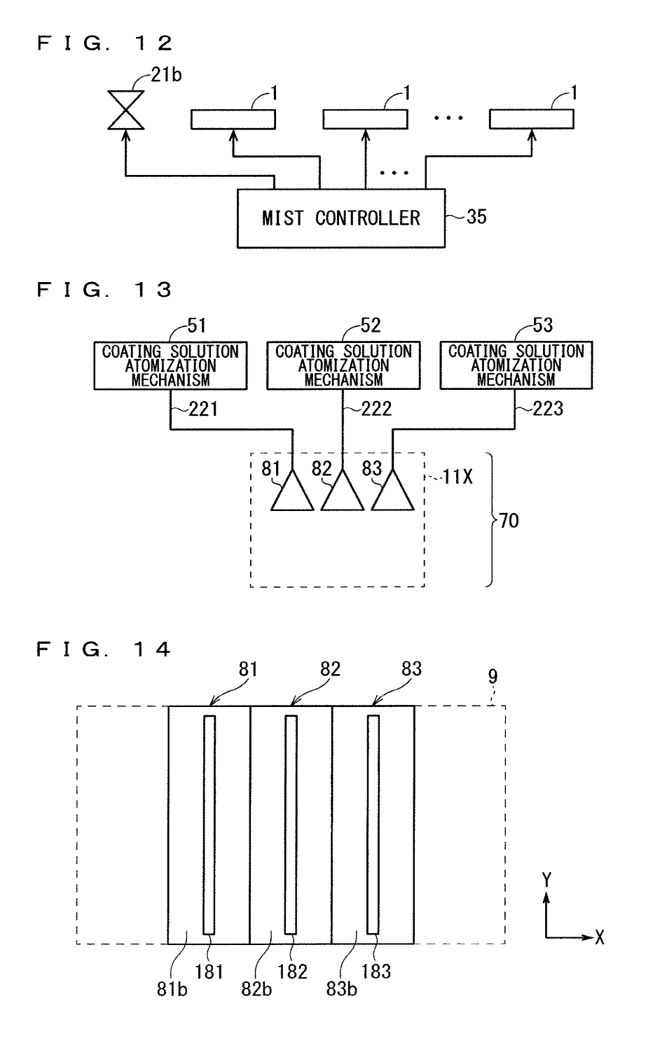

FIG. 12 is an explanatory view schematically showing the control contents of the mist controller 35 in the coating solution atomization mechanism 50 of Embodiment 2. The configuration other than that shown in FIG. 12 is the same as that of Embodiment 1 shown in FIG. 1. In the coating solution atomization mechanism 50 of Embodiment 2, a plurality of ultrasonic transducers 1 are provided under a water tank 2.

As shown in FIG. 12, the mist controller 35 can individually control on/off operation and ultrasonic vibration frequency of each of the plurality of ultrasonic transducers 1. Therefore, the mist controller 35 can determine the number of operating transducers, which is the number of ultrasonic transducers to be operated among the plurality of ultrasonic transducers 1. Further, the mist controller 35 can variably control the carrier gas flow rate of the carrier gas supplied from the carrier gas supply part 16 within the range of 2 to 10 (L/min) by controlling the degree of opening and closing of the valve 21b.

The atomization amount of the coating solution mist 6 (supply amount of the coating solution mist 6 to the mist coating mechanism 70 per unit time) can be determined by the above-mentioned number of operating transducers, the ultrasonic frequency of each ultrasonic transducer 1, and the carrier gas flow rate. In this case, the atomization amount of the coating solution mist 6 has a positive correlation with the number of operating transducers and the carrier gas flow rate, and has a negative correlation with the ultrasonic frequency. Accordingly, when the ultrasonic frequency of the ultrasonic transducer 1 (not many set to the same frequency among a plurality of ultrasonic transducers 1) is fixed, the atomization amount of the coating solution mist 6 can be adjusted by increasing and decreasing the number of operating transducers and the carrier gas flow rate.

Further, the particle size of the coating solution mist 6 coated to the surface of the substrate 9 is controlled based on the concentration of the coating solution 5, the atomization amount of the coating solution mist 6, the moving speed of the moving stage 10 and the like, and finally, the film thickness of the thin film to be formed on the surface of the substrate 9 can be determined. In this case, the film thickness of the thin film has a positive correlation with the concentration of the coating solution 5 and the atomization amount of the coating solution mist 6, and has a negative correlation with the moving speed of the moving stage 10.

Here, when conditions other than the concentration of the coating solution 5, the moving speed of the moving stage 10, the operating frequency and the carrier gas flow rate are fixed, the film thickness of the thin film formed on the surface of the substrate 9 can be adjusted by the atomization amount of the coating solution mist 6 (determined by a combination of the number of operating transducers and the carrier gas flow rate).

Therefore, in consideration of the moving speed of the moving stage 10 and the like, it is possible to control the number of operating transducers and the carrier gas flow rate under the control of the mist controller 35 such that a thin film having a desired film thickness can be formed. As a result, it is possible to improve production efficiency at the time of forming a thin film.

As described above, the mist coating forming apparatus of Embodiment 2 can form a thin film having a desired film thickness on the surface of the substrate 9 with high uniformity by controlling, by the mist controller 35 which is an atomization controller, the number of operating transducers in the plurality of ultrasonic transducers 1 and the carrier gas flow rate in the carrier gas supplied from the carrier gas supply part 16.

### Embodiment 3

In the mist coating forming apparatus of Embodiment 1, a thin film having a film thickness of 100 nm or less can be formed on the surface of the substrate 9 by one film forming process (processes in which steps S1 to S3 in FIG. 3 are each executed once). However, in the case of uniformly forming a thin film having a relatively thick film thickness exceeding 100 nm, it is necessary to perform the film forming process two or more times. Embodiment 3 pertains to a mist coating forming apparatus for uniformly forming a thin film having a relatively thick film thickness.

FIG. 13 is an explanatory view schematically showing characteristic portions of a mist coating forming apparatus of Embodiment 3. Note that, the configuration other than that shown in FIG. 13 is the same as that of Embodiment 1 shown in FIG. 1.

As shown in FIG. 13, in Embodiment 3, there are three coating solution atomization mechanisms 51 to 53 (a plurality of coating solution atomization mechanisms) each corresponding to the coating solution atomization mechanism 50 of Embodiment 1, and the mist coating heads 81 to 83 are provided corresponding to the coating solution atomization mechanisms 51 to 53 in a mist coating chamber 11X (corresponding to the mist coating chamber 11 of Embodiment 1) of the mist coating mechanism 70. The coating solution mist 6 obtained from the coating solution atomization mechanisms 51 to 53 is supplied to the mist coating heads 81 to 83 through the mist supply lines 221 to 223. That is, the coating solution mist 6 is supplied to each mist coating head 8i (i=1, 2, or 3) from the corresponding coating solution atomization mechanism 5i via the corresponding mist supply line 22i.

The mist coating heads 81 to 83 have head bottom surfaces 81b to 83b, and mist ejection ports 181 to 183 are provided in the head bottom surfaces 81b to 83b.

FIG. 14 is a plan view showing a bottom structure of the mist coating heads 81 to 83, and also shows the XY coordinate axes. As shown in the FIG. 14, the mist ejection ports 181 to 183 of a slit shape in which the Y direction (predetermined direction) is a longitudinal direction are formed in the head bottom surfaces 81b to 83b of the mist coating heads 81 to 83.

In FIG. 14, a hypothetical plane position of the substrate 9 existing under the mist coating heads 81 to 83 is shown. The substrate 9 is configured in a rectangular shape in which a side in the X direction is a long side and a side in the Y direction is a short side.

As described above, the mist coating fanning apparatus of Embodiment 3 is provided with three coating solution atomization mechanisms 51 to 53 (a plurality of coating solution atomization mechanisms), and is provided with three mist coating heads 81 to 83 (a plurality of mist coating heads) corresponding to the three coating solution atomization mechanisms 51 to 53 in the mist coating chamber 11X of the mist coating mechanism 70, and thereby, the coating solution mist 6 can be supplied simultaneously from the three mist coating heads 81 to 83 to the surface of the substrate 9.

Therefore, in the case where the processes of steps S1 to S3 in FIG. 3 are implemented in the same manner as in Embodiment 1 using the mist coating forming apparatus of Embodiment 3, the coating solution mist 6 of about three times as compared with that of Embodiment 1 can be coated to the surface of the substrate 9 when the coating solution mist coating process in step S2 is implemented once.

As a result, as compared with the mist coating forming apparatus of Embodiment 1, the mist coating forming apparatus of Embodiment 3 has the effect of uniformly faulting a thin film having a relatively thick film thickness with a small number of film forming processes.

While the present invention has been described in detail, the foregoing description is in all aspects illustrative, and the present invention is not limited thereto. It is understood that innumerable modifications not illustrated can be envisaged without departing from the scope of the present invention.

### EXPLANATION OF REFERENCE SIGNS

1: ultrasonic transducer

4: atomization container

5: coating solution

6: coating solution mist

8, 81 to 83: mist coating head

8b, 81b to 83b: head bottom surface

9: substrate

10: moving stage

11, 11X: mist coating chamber

13: hot plate

14: baking-drying chamber

16: carrier gas supply part

18, 181 to 183: mist ejection port

21: carrier gas introduction line

22, 221 to 223: mist supply line

21b: valve

35: mist controller

37: movement controller

50 to 54: coating solution atomization mechanism

1. A mist coating forming apparatus comprising:
a coating solution atomization mechanism configured to atomize a coating solution containing a predetermined raw material in an atomization container by using an ultrasonic transducer to obtain a coating solution mist in a form of droplets;
a mist coating mechanism having a mounting part on which a substrate subjected to film formation is mounted, and configured to supply said coating solution mist to said substrate and to coat said coating solution mist to the surface of said substrate; and
a baking and drying mechanism configured to bake and dry said coating solution mist coated to the surface of said substrate to form a thin film containing said predetermined raw material on the surface of said substrate.

2. The mist coating forming apparatus according to claim 1, wherein
said ultrasonic transducer includes a plurality of ultrasonic transducers,
said coating solution atomization mechanism includes a carrier gas supply part configured to supply a carrier gas for transporting said coating solution mist toward said mist coating mechanism, and
said mist coating forming apparatus further comprises
an atomization controller configured to determine the number of operating transducers which is the number of ultrasonic transducers to be operated among said plurality of ultrasonic transducers and control a flow rate of said carrier gas.

3. The mist coating forming apparatus according to claim 1, wherein
said mist coating mechanism further includes a mist coating head configured to eject said coating solution mist from a mist ejection port, and
said mist ejection port is formed in a slit shape having a predetermined direction as a longitudinal direction.

4. The mist coating forming apparatus according to claim 3, wherein
said coating solution atomization mechanism includes a plurality of coating solution atomization mechanisms, and
said mist coating head includes a plurality of mist coating heads provided corresponding to said plurality of coating solution atomization mechanisms.

5. The mist coating forming apparatus according to claim 3, wherein
said mist coating mechanism further includes a movement controller configured to move said mounting part along a moving direction matching a lateral direction of said mist ejection port of said mist coating head, and to variably control a moving speed of said mounting part along said moving direction.

6. A mist coating forming method comprising the step of:
(a) atomizing a coating solution containing a predetermined raw material in an atomization container by using an ultrasonic transducer to obtain an coating solution mist in a form of droplets;
(b) supplying said coating solution mist to a substrate subjected to film formation and coating said coating solution mist to the surface of said substrate; and
(c) baking and drying the liquid film formed of said coating solution mist coated to the surface of said substrate to form a thin film containing said predetermined raw material on the surface of said substrate.
